(19) United States
(12) Patent Application Publication
(10) Pub. No.: US 2026/0175447 A1
(43) Pub. Date: Jun. 25, 2026

(54) ROBOTIC SYSTEM WITH RECONFIGURABLE END TOOLS

(71) Applicant: Dubai Future Foundation, Dubai (AE)

(72) Inventors: Rajkumar Muthusamy, Dubai (AE); Tanzim Ahmed, Dubai (AE); Mohammad Alhareb, Dubai (AE); Tarek Taha, Dubai (AE); Khalifa AlQama, Dubai (AE)

(73) Assignee: Dubai Future Foundation, Dubai (AE)

(21) Appl. No.: 19/426,376

(22) Filed: Dec. 19, 2025

Related U.S. Application Data
(60) Provisional application No. 63/737,084, filed on Dec. 20, 2024.

(51) Int. Cl. B25J 15/00

(52) U.S. Cl. CPC B25J 15/0052

(57) ABSTRACT

A robotic system is provided. The robotic system includes a base unit, a plurality of roll-on units that are movably and rotatably connected to the base unit, and a plurality of suction gripper units that are expendably connected to the base unit. The robotic system provides a combination of modularity, multi-modal actuation, and real-time adaptability.

### CROSS-REFERENCE TO RELATED APPLICATIONS

The present application claims priority to U.S. Provisional Patent Application No. 63/737,084, titled “ROBOTIC SYSTEM WITH RECONFIGURABLE END TOOLS AND METHOD FOR PRECISE ITEMSTOCKING, STORAGE AND RETRIEVAL” and filed on Dec. 20, 2024, the entire contents of which is hereby incorporated by reference herein for all purposes.

### TECHNICAL FIELD

The present disclosure relates to a robotic system and in particular to a robotic system with reconfigurable end tools for precise item stocking, storage, and retrieval.

### BACKGROUND

In modern logistics, industries, and the service sector, there is a growing need for robots capable of performing multiple operations simultaneously to increase efficiency and productivity. Common tasks in warehouses, retail environments, and dark stores include stocking, storing, and retrieving items from shelves, bins, and tables. These tasks require a variety of physical interactions and engagements with the robot's end tool, beyond basic navigation and manipulation. The challenge is to perform these operations efficiently without requiring multiple robots or different end-tools for each task, which would increase operational costs and workspace requirements.

Accordingly, systems that address the above-mentioned issues remain highly desirable.

This disclosure introduces a novel end-tool system designed for precise stocking, storage, and retrieval of items from shelves, bins, and tables. Such interactions are typical in warehouses, retail stores, dark stores, and grocery stores. The end-tool system features a reconfigurable, modular, and multi-functional design with multi-modal actuation and sensing capabilities.

### SUMMARY

In accordance with one aspect of the present disclosure, a robotic system includes a base unit, a plurality of roll-on units that are movably and rotatably connected to the base unit, and a plurality of suction gripper units that are expendably connected to the base unit.

In accordance with one aspect of the present disclosure, each of the roll-on units includes a conveyor belt, where stiffness of the conveyor belt is adjustable.

In accordance with one aspect of the present disclosure, the robotic system includes three of the roll-on units. Two of the roll-on units are movable to be located at two sides of the other one of the roll-on unit.

In accordance with one aspect of the present disclosure, the robotic system includes two of the suction gripper units that are respectively located at the two sides of the other one of the roll-on unit.

In accordance with one aspect of the present disclosure, the roll-on units are movable to be horizontally parallel to each other.

In accordance with one aspect of the present disclosure, the robotic system further includes a vision sensor that is located over the roll-on units.

In accordance with one aspect of the present disclosure, the robotic system further includes two vision sensors that are respectively located over and below the roll-on units.

In accordance with one aspect of the present disclosure, the robotic system further includes a plurality of proximity sensors that are located at front ends of the roll-on units.

In accordance with one aspect of the present disclosure, the robotic system further includes a plurality of tactile sensors that are located at front ends of the roll-on units.

In accordance with one aspect of the present disclosure, the robotic system is configured to: pick up an object by suction force of the suction gripper units to transfer the object onto the roll-on units.

In accordance with one aspect of the present disclosure, the robotic system is further configured to move the object along the roll-on units.

In accordance with one aspect of the present disclosure, the robotic system is further configured to grip the object with the toll-on units after the object is moved along the roll-on units.

In accordance with one aspect of the present disclosure, the robotic system is configured to grip an object with the two of the roll-on units at two sides of the other one of the roll-on unit.

In accordance with one aspect of the present disclosure, the robotic system is further configured to move the object along the roll-on units while the object is gripped by the roll-on units.

In accordance with one aspect of the present disclosure, the robotic system is further configured to rotate the object on the roll-on units while the object is gripped by the roll-on units.

In accordance with one aspect of the present disclosure, the robotic system is configured to: grip an object with the two of the roll-on units at two sides of the other one of the roll-on unit, so that the object faces a first direction; and rotate each of the roll-on units relative to the base unit, so that the object faces a second direction different from the first direction.

In accordance with one aspect of the present disclosure, the robotic system is coupled to a robot arm and is movable with the robot arm. The robotic system is configured to grip an object with the roll-on units. The robotic system is further configured to reorient the object through the roll-on units when the roll-on units grip the object and when the robotic system moves with the robot arm.

### BRIEF DESCRIPTION OF THE DRAWINGS

Further features and advantages of the present disclosure will become apparent from the following detailed description, taken in combination with the appended drawings, in which:

FIGS. 1-1 and 1-2 respectively illustrate a perspective view and a top view of a robotic system;

FIG. 2-1 shows a parallel gripping configuration of multiple roll-on units of the robotic system; FIG. 2-2 shows a parallel unit configuration of the roll-on units; and FIG. 2-3 shows that suction endpoints of multiple suction gripper units of the robotic system extending outward for engaging and holding actions;

FIGS. 3-1 and 3-2 illustrate different of field of views of vision sensors of the robotic system;

FIGS. 4-1 to 4-3 are top views illustrating an object being sucked and moved by the suction gripper units of the robotic system;

FIGS. 5-1 to 5-7 illustrate the use of the robotic system to move an object using the suction gripper units and the roll-on units;

FIGS. 6-1 to 6-6 illustrate different modes of operating the roll-on units;

FIGS. 7-1 to 7-4 are top views illustrating an object being held by and moved along the roll-on units;

FIGS. 8-1 and 8-2 also illustrate different modes of operating the roll-on units with a robotic arm;

FIGS. 9-1 to 9-9 show different steps of removing an object from a shelf, placing the object into a bin, removing the object from the bin, and placing the object onto the shelf;

FIGS. 10-1 to 10-4 illustrate that an object is moved from one shelf to another by the robotic system; and

FIGS. 11-1 to 11-6 illustrate different modes of handling an object by the roll-on units.

It will be noted that throughout the appended drawings, like features are identified by like reference numerals.

### DETAILED DESCRIPTION

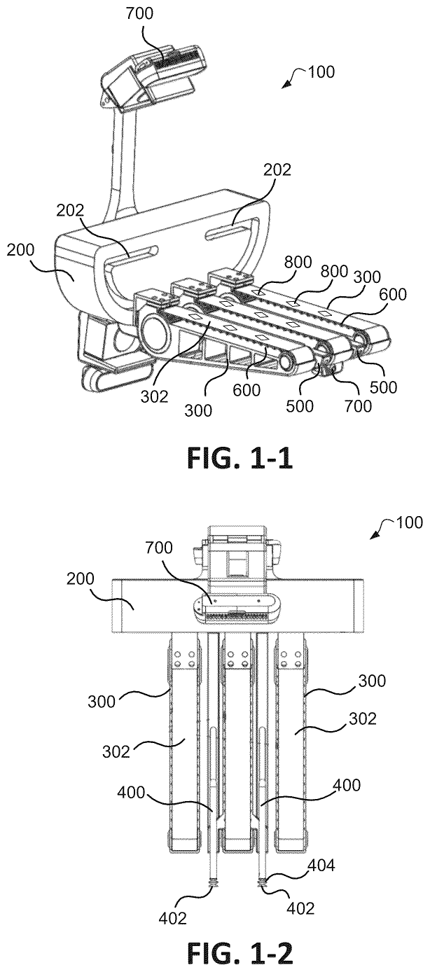

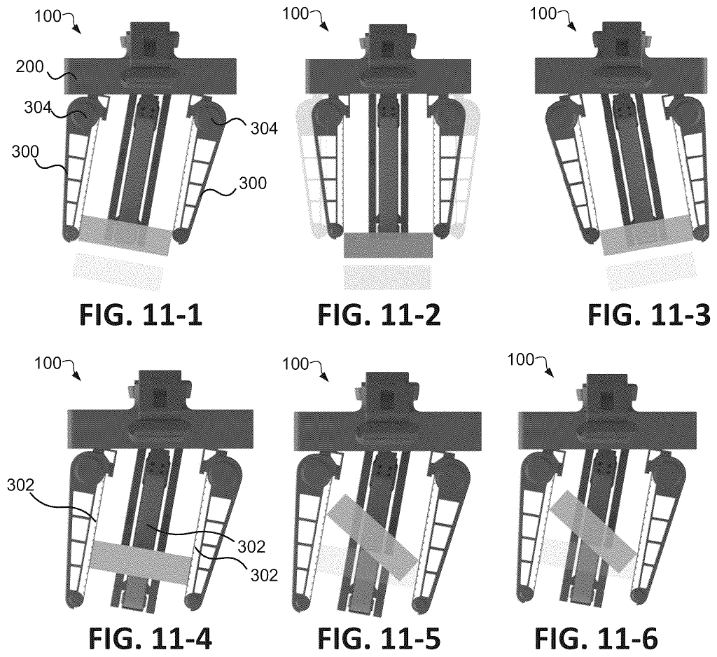

Embodiments are described below, by way of example only, with reference to Figures. 1-1 to 11-6.

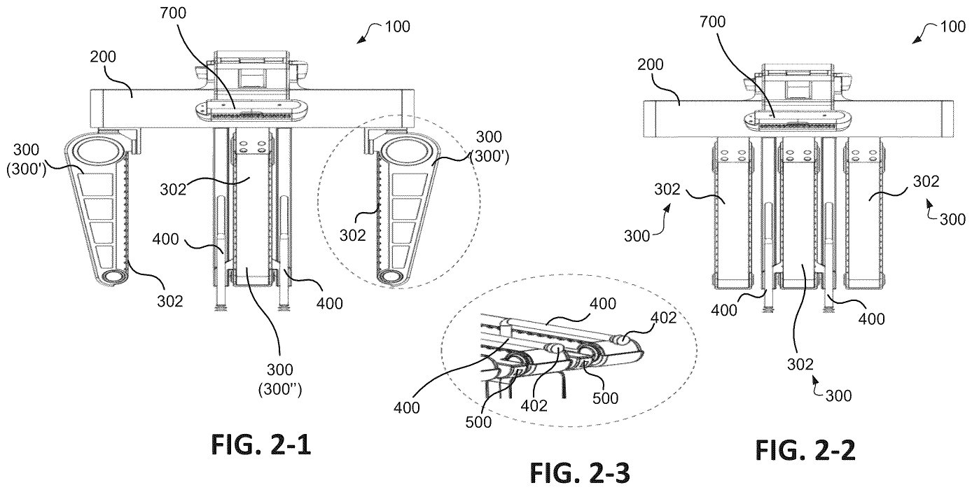

FIGS. 1-1 and 102 illustrate an exemplary embodiment of a robotic system 100, in which FIG. 1-1 is a perspective view of the robotic system 100 and FIG. 1-2 is a top view. The robotic system 100 includes a base unit 200, a plurality of roll-on units 300, and a plurality of suction gripper units 400. In some embodiments, the robotic system may further include a plurality of proximity sensors 500, a plurality of tactile sensors 600, and a plurality of vision sensors 700.

The base unit 200 may provide rotational actuation and serve as the support structure for the other reconfigurable units and their reconfigurable actuations. In some embodiments, two vision sensors 700 are provided: one at the top observing the roll-on and suction gripper units 300, 400 and the object being handled, and one at the bottom observing the roll-on units 300 and their reconfigured motions using embedded markers 800. This dual-sensor setup offers comprehensive monitoring and control, facilitating precise gripping to in-hand manipulation. Moreover, they allow scanning of items for tagged information (e.g., bar codes, QR codes, etc.) and reorients objects to extract this information if not initially visible. The embedded markers 800 are to be observed by the vision sensors 700 and sensor data will be processed to perform precise control.

The vacuum gripping is achieved by moving suction endpoints 402 of the suction gripper units 400, which extend outwardly to pull items towards the robotic system 100. For example, a box on a shelf can be pulled onto the roll-on units 300 positioned parallel to the box. The suction gripper units 400 may employ linear and rotational actuation to execute the pull-in and suction gripping action. It is integrated with the proximity sensors 500 (e.g., IR transceivers) to measure the distance between the robotic system 100 and the item, preventing collisions and serving as a safety mechanism. Tactile sensors 600 (e.g., contact sensors, or tactile bumps) act as contact sensors to halt operations of the robotic system 100 if, for example, the proximity sensors 500 fail. In other embodiments, the tactile sensors 600 and the proximity sensors 500 may work collectively to enhance operation and safety of the robotic system 100. At least one of the suction gripper units 400 may be equipped with a vision sensor 404 (e.g., RGB-D, monocular, or neuromorphic cameras) in an eye-in-hand configuration for detecting items, extracting tagged information for stock-keeping, and guiding the robot to the grasp pose.

In other configurations, the suction gripper units 400 may be respectively located at the two sides of the other one of the roll-on units 300, all together in center mounted on the base unit 200 that is rotatable along the Y-axis. During parallel gripping, the roll-on units 300 and the suction gripper units 400 reorient perpendicular to a gripping axis, ensuring an unobstructed operation for the parallel gripper. This design allows seamless object handling by combining suction, rolling, and gripping capabilities, while maintaining flexibility and efficiency for diverse tasks. The gripper configuration can be applied while placing an object in a bin/shelf.

The roll-on units 300 combine active surfaces 302 in the form of conveyor belts with the embedded markers 800 on the sides (e.g., on the conveyor belts). The conveyor belts are adjustable in stiffness in real time to accommodate different needs. For example, when gripping a heavy object, the stiffness of the conveyor belt may be increased to ensure a firm grip. In some embodiments, the robotic system 100 may include two reconfigurable variable stiffness roll-on units and one static roll-on unit. These units can be configured in two primary ways: (1) parallel unit configuration, where all three roll-on units are aligned parallel to each other, allowing items pulled in by the vacuum gripper to move smoothly within the robotic system for stable holding; and (2) parallel gripping configuration, where the side roll-on units are reoriented (e.g., along the grooves 202 formed in the base unit 200) for in-hand manipulation, allowing for translation (XYZ), rotation (RPY), shift, finger gaiting, and coordinated object handling. For XYZ translation, the X-axis translation may be a forward-backward movement, the Y-axis translation may be a side-to-side movement, the Z-axis translation may be a yaw movement. In addition, a diagonal translation may be achieved and may be a movement combining X- and Y-directions. In addition, a helical motion may be achieved and may be a movement combining translation and rotation. The various forms of translation may be achieved by rotation of the base unit 200 and/or the shapes of the frooves 202.

In some embodiments, the robotic system 100 can be configured for four applications: (1) simple suction gripping, where the base unit 200 re-orients to directly use of the suction gripper units 400 for pick-and-place operations; (2) pull-in and roll-on conveyor actuation, where items are retrieved or stocked from or to shelves or tablets using the suction gripper units 400 and the roll-on units 300; (3) reorientation and gripping, where the side roll-on units reconfigure to parallel gripping, enabling 5-axis (including X-axis, Y-axis, Z-axis, diagonal, and helical translations), in-hand manipulation using multi-modal sensing; and (4) storage bin placement, where the gripped item is reoriented by the base unit 200 for precise placement in storage bins.

In some embodiments, the robotic system 100 is configured to integrate with both stationed and mobile robotic manipulators, enabling a comprehensive range of functions. It can pick items from incoming shelves, tables, or multiple shelf/table units, ensuring seamless handling of goods. The tool can extract tagged information from items, such as barcodes or QR codes, facilitating efficient inventory management. Additionally, it can reorient objects for desired stocking poses, allowing precise placement on outgoing platforms, shelves, tables, or multiple shelf/table units.

When integrated with a robotic mobile manipulator, the end tool supports autonomous navigation, storage, and transport of items. This integration enables complex and dexterous operations such as stocking, storing, and retrieving items from shelves, bins, and tables. It is particularly beneficial in warehouses, retail stores, dark stores, grocery stores, ports, logistics, and service sectors. The end tool significantly improves efficiency and productivity by reorienting objects after picking and while the mobile manipulator is in motion, ensuring optimal handling and placement of items.

An exemplary operation sequence involves a mobile manipulator navigating a warehouse, detecting and retrieving an item from a shelf, storing it in a storage bin, and moving it to another location to stock it on a shelf. The robotic system can handle various items, from standard boxes to general-purpose items, and can be customised for different sizes, types, and weights. The robotic system is scalable, modular, cost-effective, and adaptable, providing a versatile solution for modern robotic applications.

With its advanced sensing, actuation, and reconfiguration capabilities, the robotic system offers a comprehensive solution for the precise stocking, storage, and retrieval of items, enhancing operational efficiency in diverse industrial and service settings.

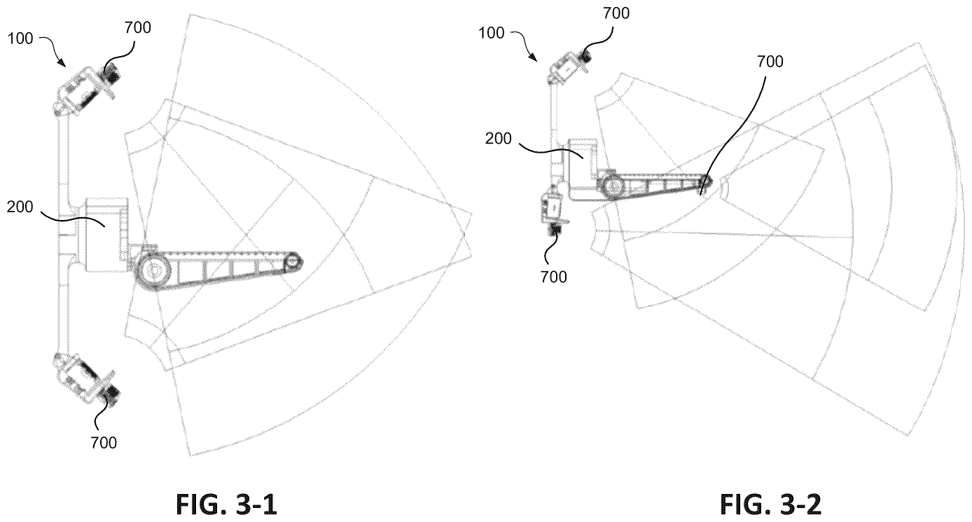

FIGS. 2-1 to 2-3 illustrate different configurations of the roll-on units 300 of the robotic system 100. FIG. 2-1 shows the parallel gripping configuration, where the side roll-on units 300′ are reoriented to two sides of the middle roll-on units 300″, so that the roll-on units 300 collaboratively hold an object. In some embodiments, while the roll-on units 300 is holding the object, the active surfaces 302 (e.g., the conveyor belts) may move, realizing in-hand manipulation of the object. FIG. 2-2 shows the parallel unit configuration, where all three roll-on units 300 are aligned parallel to each other, allowing an object pulled in by the suction gripper units 400 to move smoothly within the robotic system for stable holding. Similarly, after the object is pulled-in, the active surfaces 302 (e.g., the conveyor belts) may move, allowing the object to move on the roll-on units 300. FIG. 2-3 illustrates the suction endpoints 402 of the suction gripper units 400 extending outward to engage and hold the object.

FIGS. 3-1 and 3-2 respectively represent two possible vision sensor configurations for different field of views (FOVs). In FIG. 3-1, the robotic system 100 is provides with two vision sensors 700 that are respectively located at two sides (e.g., top side and bottom side) of the base unit 200. In FIG. 3-2, other than the two vision sensors 700 located at the two sides of the base unit 200, the robotic system 100 is further provided with another vision sensor 700 located at, for example, one of the roll-on units 300 for even better view angles. In other embodiments, each roll-on unit 300 may be provided with at least one vision sensor.

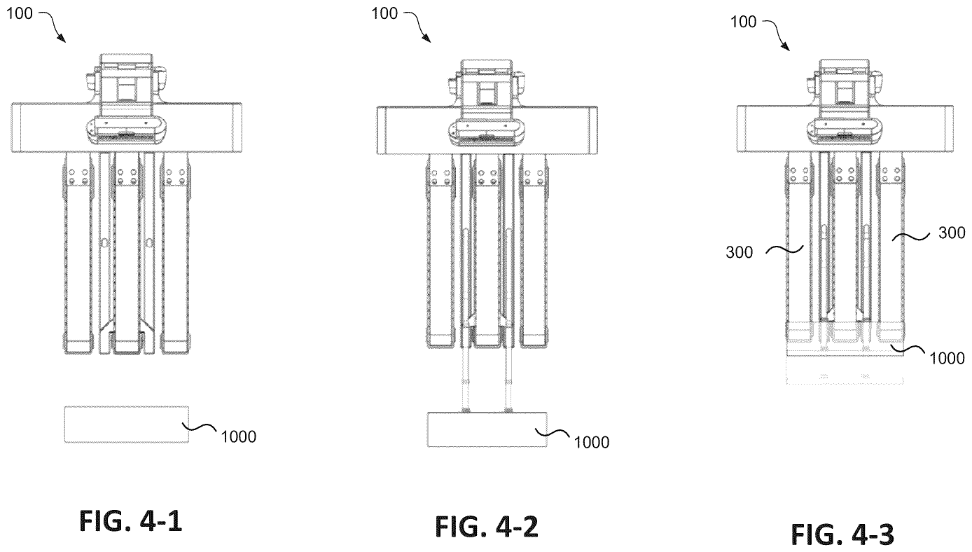

FIGS. 4-1 to 4-3 illustrate suction-gripping operation of the robotic system 100. In FIG. 4-1, the robotic system 100 approaches the target object 1000, aligning itself with the target object for precise engagement. Such alignment may be accomplished with at least one of the proximity sensors 500 and the vision sensors 700 described above. FIG. 4-2 demonstrates the activation of the suction gripper units 400 (see FIG. 2-3), effectively adhering to the surface of the target object through the suction endpoints 402 to ensure a secure grip. FIG. 4-3 depicts the subsequent phase, where the target object is carefully pulled onto the reconfigurable roll-on units 300, facilitating stable handling and transport.

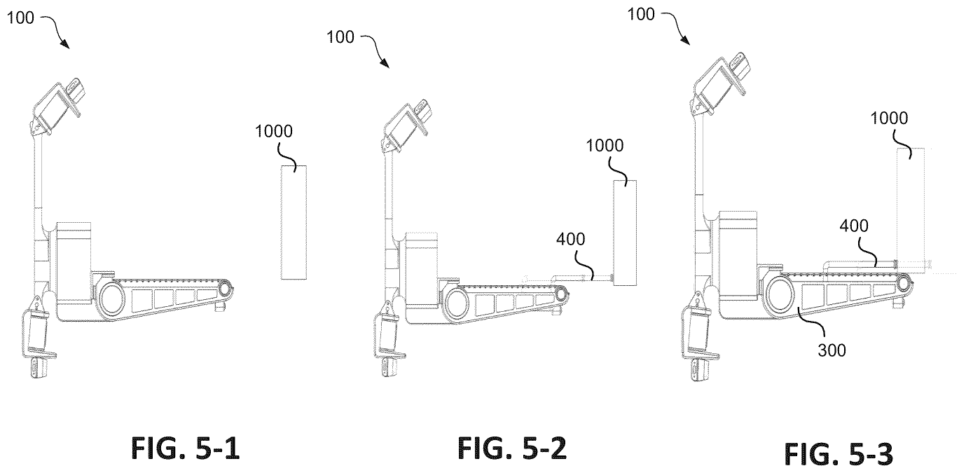

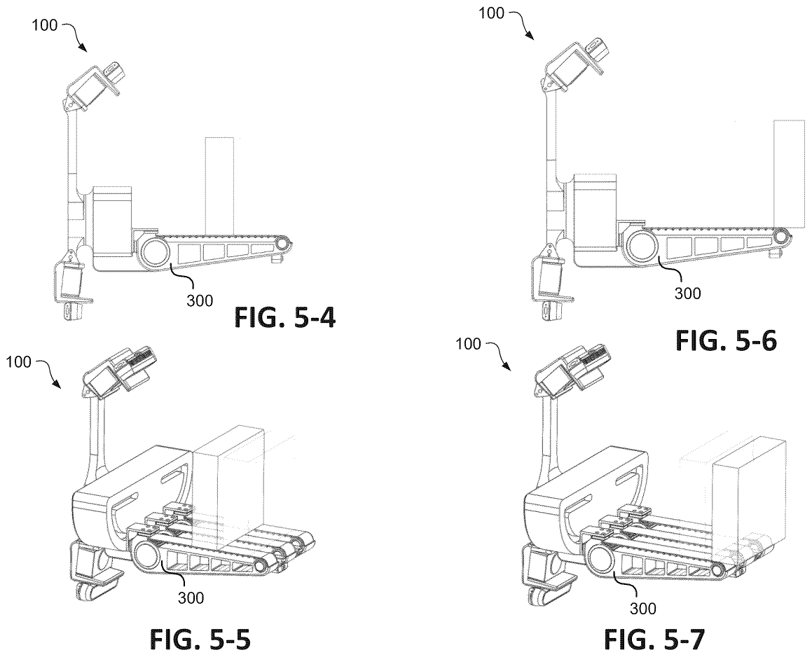

FIGS. 5-1 to 5-7 illustrate the pull-in and roll-on conveyor actuation end-tool configurations, where FIG. 5-1 represents the robotic system 100 approaching the target object 1000 and aligning for precise engagement. FIG. 5-2 shows the suction gripper units 400 attaching securely to the object's surface. FIG. 5-3 depicts the target object being pulled onto the roll-on units 300 by the suction gripper units 400. FIGS. 5-4 and 5-5 demonstrate the activation of the roll-on units 300, pulling the target object inward for secure transport. FIGS. 5-6 and 5-7 illustrate the ability of the roll-on units 300 to reverse rotation, allowing the target object to be moved outward, enabling flexible handling and positioning.

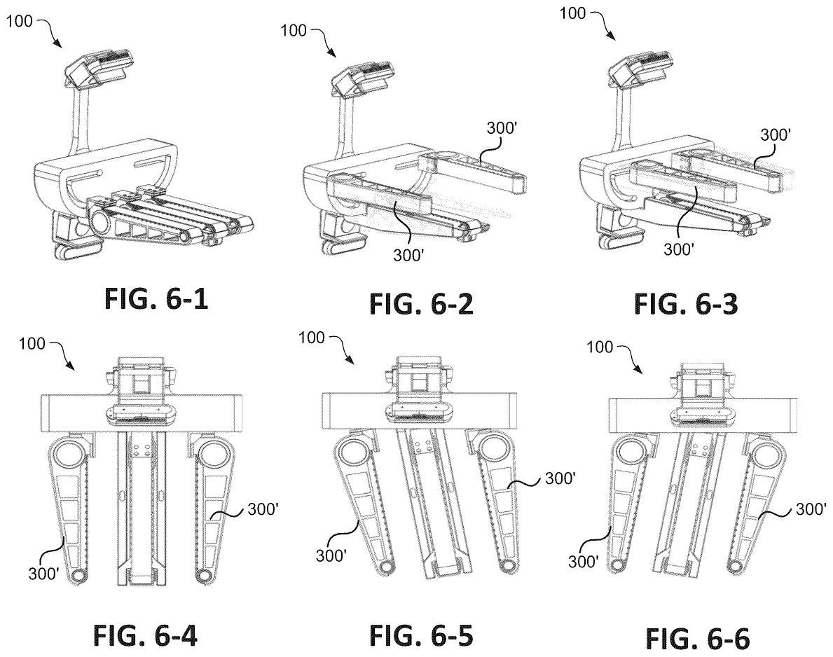

FIGS. 6-1 to 6-6 represent parallel gripping and roll-on independent actuation of the end-tool configurations. FIG. 6-1 represents a standard configuration as previously described with reference to FIGS. 4-1 to 5-7. FIG. 6-2 shows that the left and right side roll-on units (i.e., the side roll-on units 300′) are reorientated to create a parallel gripping configuration. FIG. 6-3 shows that the gripping mechanism by linearly (e.g., horizontally) actuating opposite roll-on units (i.e., the side roll-on units 300′) toward each other. FIGS. 6-4 to 6-6 show that the roll-on units (i.e., the side roll-on units 300′) are able to shift their angular positions (i.e., finger gaiting).

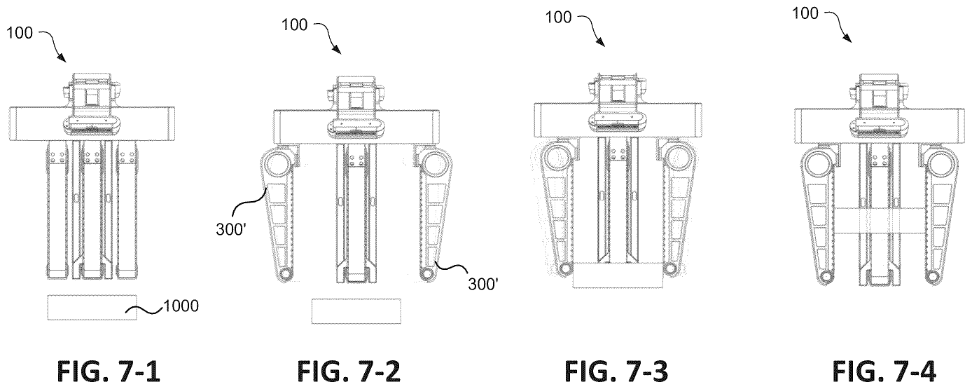

FIGS. 7-1 to 7-4 illustrate the roll-on conveyor actuation with a top-down parallel end-tool configuration. FIG. 7-1 represents the robotic system 100 approaching the target object 1000, aligning for precise engagement through, for example, the proximity sensors 500 and the vision sensors 700 (see FIG. 1-1). FIG. 7-2 shows the reconfiguration of the two roll-on units (i.e., the side roll-on units 300′) with a parallel end-tool configuration. FIG. 7-3 depicts the target object being gripped onto the roll-on units 300. FIG. 7-4 demonstrates that the activation of the roll-on conveyors of the roll-on units (i.e., the active surfaces 302 of the roll-on units 300 (see FIG. 1-1)), pulling the target object inward for secure transport.

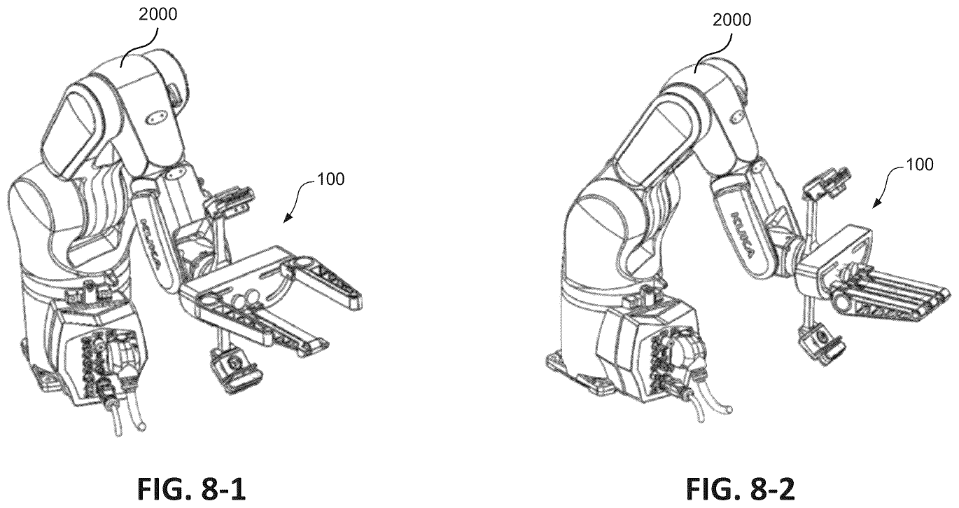

FIGS. 8-1 and 8-2 show that the robotic system 100 is mounted to and operable with a robot arm 2000, where: FIG. 8-1 is the parallel gripping configuration as previously described with reference to FIGS. 6-2, 6-3, and 7-2; and FIG. 8-2 is the parallel unit configuration as previously described with reference to FIGS. 4-1 to 5-7.

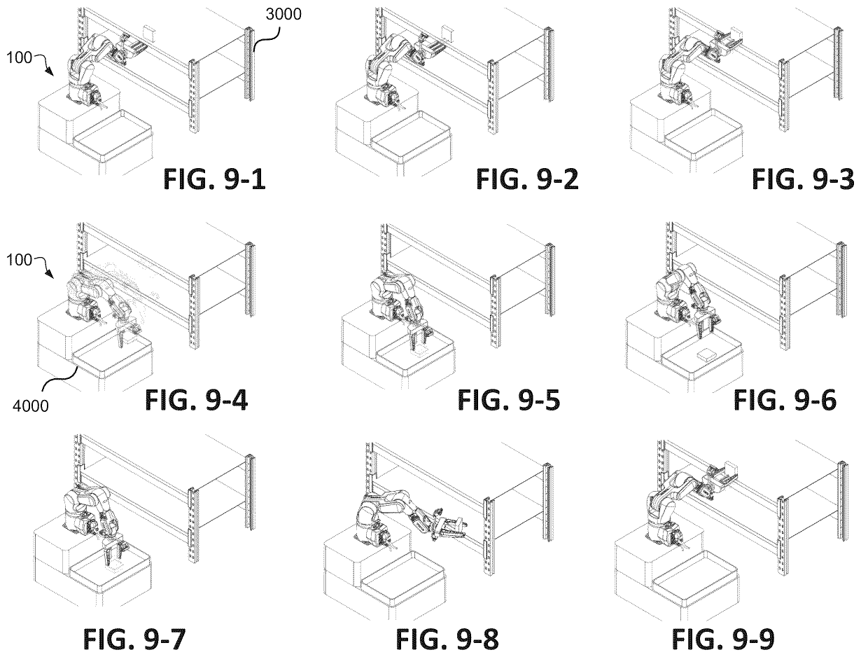

FIG. 9 illustrates an exemplary warehouse robot cycle (including, for example, retrieval, storing, stocking, etc.) placement end-tool configurations, where FIG. 9-1 shows that the robotic system 100 approaching a shelf 3000 where an object is located, FIG. 9-2 depicts the suction gripper units 400 (see also FIGS. 4-1 to 4-3) being used to position the object for parallel gripping, FIG. 9-3 represents the roll-on configuration being changed to parallel gripping (see also FIGS. 7-1 to 7-4) to grip the object on the shelf, FIG. 9-4 shows the robotic system 100 lifting the object off the shelf, beginning to transfer it to a storage bin 4000, FIG. 9-5 illustrates the robotic system moving the object toward the storage bin, aligning it for proper placement, FIG. 9-6 depicts the robotic system placing the object into the bin and releasing it to complete the transfer, and ensuring the object is securely stored in the bin, FIG. 9-7 illustrates the parallel configuration to grip the object from the storage bin, FIG. 9-8 shows the object being transferred to the shelf, and FIG. 9-9 shows the object being placed on the shelf.

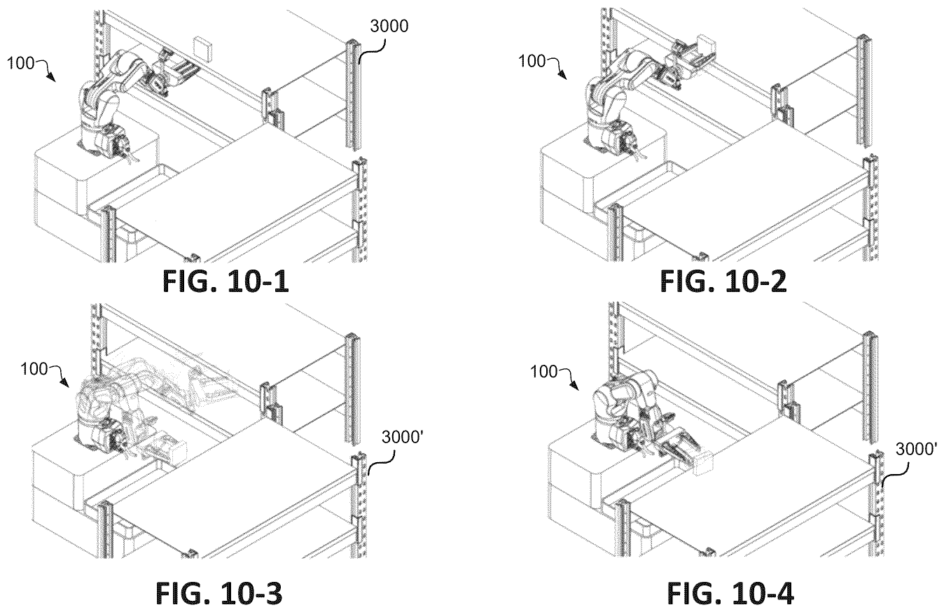

FIGS. 10-1 to 10-4 illustrate a stationed manipulator (e.g., the robotic system 100) picking an incoming item from the shelf 3000 (see FIGS. 10-1 and 10-2), reorienting the item (FIG. 10-3), and placing the item on an outgoing shelf 3000′ (see FIG. 10-4), where in-hand manipulation may be performed on the move. Specifically, FIG. 10-1 represents the end tool (i.e., the robotic system 100) approaching the object and getting ready to change its configuration. FIG. 10-2 shows that the end tool uses parallel gripping (see also FIGS. 7-1 to 7-4) to grip the object securely. FIG. 10-3 shows that the object is moved to the outgoing shelf 3000′, where the object may be reoriented in-hand during transferring from the shelf 3000 to the outgoing shelf 3000′. FIG. 10-4 shows that the object is securely placed on the outgoing shelf 3000′.

Although FIGS. 9-1 to 10-4 are exemplified to operation relative to the shelf or storage bin, it should be noted that the robotic system of this disclosure is capable of interacting with the object on any kind of environments, such as ground, table, shelf, box, etc. For example, the suction and then roll-on operations can be used for retrieving an object on a shelf; the parallel gripping configuration can be used for gripping an object on a table; and the suction operation can be used for picking up an object on the ground.

FIGS. 11-1 to 11-6 show different modes of handling the object with the robotic system 100. FIGS. 11-1 to 11-3 correspond to the embodiment of FIGS. 6-4 to 6-6 (i.e., gating operation). When the roll-on units 300 of the robotic system 100 grip the object, the roll-on units 300 may rotate relative to the base unit 200 through multiple joints 304 to achieve the gating movement, which may be particularly useful in moving the object in tight spaces, between close shelves, etc. As shown in FIGS. 11-4 to 11-6, other than gating movement, the object may be reoriented (e.g., rotated) when the roll-on units 300 grip the object. This may be achieved by relative movement/rotation of the active surface 302 (e.g., conveyor belts) of the roll-on units 300. Such reorientation movement may be helpful when it is needed to reorientate the object relative to a specific target (e.g., a shelf).

It should be noted that the object may be reorientated during movement of the robotic system. For example, referring to FIGS. 10-2 and 10-3, when the robotic system 100 is moving the object from the shelf 3000 to the outgoing shelf 3000′, the roll-on units 300 may be actuated to rotate and/or reorient the object (e.g., the reorientation shown in FIGS. 11-4 to 11-6). Such “reorientation on the go” feature may be particularly desirable for saving time without having to reorientation the object after the robotic system stops moving, and for changing the direction of the object so that it can be more efficiently and safely placed to a target location.

The robotic system of this disclosure integrates modular designs, multi-modal actuation, advanced sensing, and real-time adaptability, thereby offering a more comprehensive solution for various applications.

The robotic system is capable of reconfiguring its three actuation units: the base unit, the roll-on units, and the suction gripper units that are combined in a single end tool (i.e., the robotic system). This modular approach provides flexibility in different applications. The advanced sensing capabilities, including the dual-camera setup for in-hand manipulation, provides precise control of the robotic system.

Moreover, the robotic system's real-time stiffness adjustment capability enables dynamic manipulation of objects of varying sizes and weights. This is a feature that surpasses the capabilities of existing multi-gripper systems with addressable vacuum regions, which focus more on the distribution of gripping forces. This flexibility is further enhanced by the robotic system's ability to reorient items during manipulation, which is a capability that allows for precise placement and handling, setting it apart from designs that prioritize adaptability without the same level of precision.

While compact robotic grippers with palm-mounted sensing have made strides in integrating sensing and computing components, they do not offer the same level of modularity or adaptability as the present disclosure. Additionally, a Belt-Augmented Compliant Hand (BACH) and other tactile-focused grippers emphasize in-hand manipulation but lack the comprehensive, reconfigurable design and advanced sensing capabilities of the robotic system of this disclosure.

In summary, the robotic system provides a unique combination of modularity, multi-modal actuation, and real-time adaptability, making it a versatile and powerful tool for robotic manipulation while eliminate the need for multiple specialized grippers. This approach not only addresses the limitations of existing technologies but also sets a new standard for future developments in the field.

The robotic system distinguishes itself from existing technologies through its reconfigurable, modular, and multi-functional design with multi-modal actuation and sensing capabilities. The robotic system offers a modular design, where the robotic system consists of three actuation units (i.e., the base unit, the roll-on units, and the suction gripper units) that can be reconfigured for various tasks, eliminating the need for multiple end-tools or robots. The robotic system also offers multiple-modal actuation, where the robotic system combines different actuation methods (e.g., rotational, linear, vacuum, etc.) within a single tool, providing the flexibility to handle a wide range of tasks, from simple suction gripping to complex in-hand manipulation. The robotic system also provides advanced sensing, where it is equipped with multiple sensors (e.g., the contact sensors, the proximity sensors, the vision sensors, etc.) to offer precise controlling and monitoring to enhance safety and efficiency. The dual-camera setup provides comprehensive in-hand manipulation capabilities. The robotic system also offers real-time stiffness adjustment, where the roll-on units' conveyor belts can adjust its stiffness in real-time, enabling stable holding and manipulation of items of varying sizes and weights. The robotic system also provides reorientation capabilities, where the robotic system can reorient items during manipulation, allowing for precise placement and handling in various configurations (e.g., parallel gripping, reorientation for storage bin placement, etc.).

The robotic system may be applied to various fields, such as warehouse automation, retail, e-commerce, healthcare, pharmaceuticals, consumer robotics, agriculture processing, food processing, logistics, supply chain, research and development, space exploration, etc.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A robotic system comprising:
a base unit;
a plurality of roll-on units that are movably and rotatably connected to the base unit; and
a plurality of suction gripper units that are expendably connected to the base unit.

2. The robotic system of claim 1, wherein each of the roll-on units includes a conveyor belt, stiffness of the conveyor belt being adjustable.

3. The robotic system of claim 2, wherein:
the robotic system comprises three of the roll-on units; and
two of the roll-on units are movable to be located at two sides of the other one of the roll-on unit.

4. The robotic system of claim 3, wherein the robotic system comprises two of the suction gripper units that are respectively located at the two sides of the other one of the roll-on unit.

5. The robotic system of claim 3, wherein the roll-on units are movable to be horizontally parallel to each other.

6. The robotic system of claim 1, further comprising a vision sensor that is located over the roll-on units.

7. The robotic system of claim 1, further comprising two vision sensors that are respectively located over and below the roll-on units.

8. The robotic system of claim 1, further comprising a plurality of proximity sensors that are located at front ends of the roll-on units.

9. The robotic system of claim 1, further comprising a plurality of tactile sensors that are located at front ends of the roll-on units.

10. The robotic system of claim 1, wherein the robotic system is configured to:
pick up an object by suction force of the suction gripper units to transfer the object onto the roll-on units.

11. The robotic system of claim 10, wherein the robotic system is further configured to move the object along the roll-on units.

12. The robotic system of claim 11, wherein the robotic system is further configured to grip the object with the toll-on units after the object is moved along the roll-on units.

13. The robotic system of claim 3, wherein the robotic system is configured to grip an object with the two of the roll-on units at two sides of the other one of the roll-on unit.

14. The robotic system of claim 13, wherein the robotic system is further configured to move the object along the roll-on units while the object is gripped by the roll-on units.

15. The robotic system of claim 13, wherein the robotic system is further configured to rotate the object on the roll-on units while the object is gripped by the roll-on units.

16. The robotic system of any one of claim 3, wherein the robotic system is configured to:
grip an object with the two of the roll-on units at two sides of the other one of the roll-on unit, so that the object faces a first direction; and
rotate each of the roll-on units relative to the base unit, so that the object faces a second direction different from the first direction.

17. The robotic system of claim 1, wherein:
the robotic system is coupled to a robot arm and is movable with the robot arm;
the robotic system is configured to grip an object with the roll-on units; and
the robotic system is further configured to reorient the object through the roll-on units when the roll-on units grip the object and when the robotic system moves with the robot arm.
